(19) United States
(12) Patent Application Publication
(10) Pub. No.: US 2010/0259628 A1
(43) Pub. Date: Oct. 14, 2010

(54) CAMERA

(76) Inventor: Martin Rous, Friolzheim (DE)

Correspondence Address: KENYON & KENYON LLP, ONE BROADWAY, NEW YORK, NY, 10004, US

(21) Appl. No.: 12/452,638

(22) PCT Filed: Jun. 16, 2008
(86) PCT No.: PCT/EP2008/057573

§ 371 Date: Jun. 21, 2010

(30) Foreign Application Priority Data
Jul. 25, 2007 (DE) 102007034608.7

(51) Int. Cl. H04N 5/228; H01J 40/14; H04N 9/07

(52) U.S. Cl. 348/222.1; 250/226; 348/339; 348/E05.031; 348/E09.003

(57) ABSTRACT

An image sensor having light-sensitive elements situated in rows and columns, a camera, and a camera system are provided. The image sensor has a repeating pattern including two adjacent rows, the first row having alternating light-sensitive elements having a blue filter and light-sensitive elements having a red filter, and the second row having light-sensitive elements having no blue filters and no red filters, i.e., no color filter.

### BACKGROUND OF THE INVENTION

1. Field of the Invention

The present invention relates to an image sensor having light-sensitive elements situated in rows and columns, a camera, and a camera system.

2. Description of Related Art

Published European patent document EP 0 427 400 discloses an image sensor in which a four-color filter, which is made up of cyan, magenta, yellow, and green, is combined with a solid body image sensor element. An image recording device is known from published German patent document DE 10 2005 061 366 which uses a Bayer color pattern having the three colors green, blue, and red so that each pixel of the image sensor generates image data corresponding to the colors green, blue, and red.

### BRIEF SUMMARY OF THE INVENTION

The image sensor described hereinafter, the camera having such an image sensor, and the camera system have the advantage of a greater separation performance between red and white. Due to the color-filtered row of light-sensitive elements having blue filters and red filters, it may be established unambiguously in an advantageous manner whether or not it is a red colored object, e.g., the tail light of a motor vehicle. Due to the alternation of color-filtered rows and rows without color filters, e.g., uneven rows color-filtered and even rows unfiltered, it is possible in an advantageous manner to use row-oriented image processing algorithms which are based on pure intensity image data, i.e., on the image signals of the light-sensitive elements without color filters. This advantageously adds to a high processing speed, since it is not necessary to adapt or convert the color-filtered image data.

Another advantage of the unfiltered rows is that the maximum sensitivity is maintained at these points. A color filter generally does not operate loss-free. Applications which must detect low-lighting light sources must lose as little overall intensity as possible.

Another advantage of the subsequently described BRII pattern is that by analyzing all pixels of the described 2×2 matrix the reconstruction of the green component is possible. Due to weighted subtraction of the image signals of the light-sensitive elements without color filters, i.e., due to weighted subtraction of the red and blue components from the I-component, a green component may be deduced. There is advantageously also the possibility to deduce one color component, although this is not explicitly measured.

It is particularly advantageous that the image sensor is designed as a CMOS image sensor, because CMOS image sensors include a large dynamic range of preferably at least ten to the 8th power. This has the advantage that a color distinction is possible in the event of very bright objects as well as very low-luminosity objects.

An analyzer unit, which is designed in such a way that the analyzer unit is able to distinguish between red tail lights and white low beams of motor vehicles, has the advantage that a distinction may simply be made between oncoming vehicles and preceding vehicles. It is particularly advantageous when the analyzer unit is designed in such a way that the analyzer unit carries out this distinction by analyzing the image signals of the light-sensitive elements having blue filters and the image signals of the light-sensitive elements having red filters.

An analyzer unit, which is designed in such a way that the analyzer unit is able to distinguish between white and yellow roadway markings, has the advantage that it is easy to distinguish between these two different types of roadway markings. It is particularly advantageous when the analyzer unit is designed in such a way that the analyzer unit carries out this distinction by analyzing the image signals of the light-sensitive elements having blue filters and the image signals of the light-sensitive elements having red filters.

### BRIEF DESCRIPTION OF SEVERAL VIEWS OF THE DRAWING

FIG. 1 shows a camera system.

FIG. 2 shows a camera.

FIG. 3 shows an image sensor.

FIG. 4 shows a 2×2 matrix.

FIG. 5 shows a diagram of the transmission curves.

### DETAILED DESCRIPTION OF THE INVENTION

An image sensor having light-sensitive elements situated in rows and columns, a camera, and a camera system are described in the following. The image sensor has a repeating pattern including two adjacent rows, the first row having alternating light-sensitive elements having a blue filter and light-sensitive elements having a red filter and the second row having light-sensitive elements without a blue filter and without a red filter, i.e., without a color filter.

The exemplary embodiment described below relates to the use of the image sensor, the camera, and the camera system in a motor vehicle for supporting the driver as a driver assistance system. However, the described camera system, the camera, and the image sensor are not restricted to this use, but may also be used outside of the automotive industry, e.g., in the field of security technology, robotics and/or process engineering.

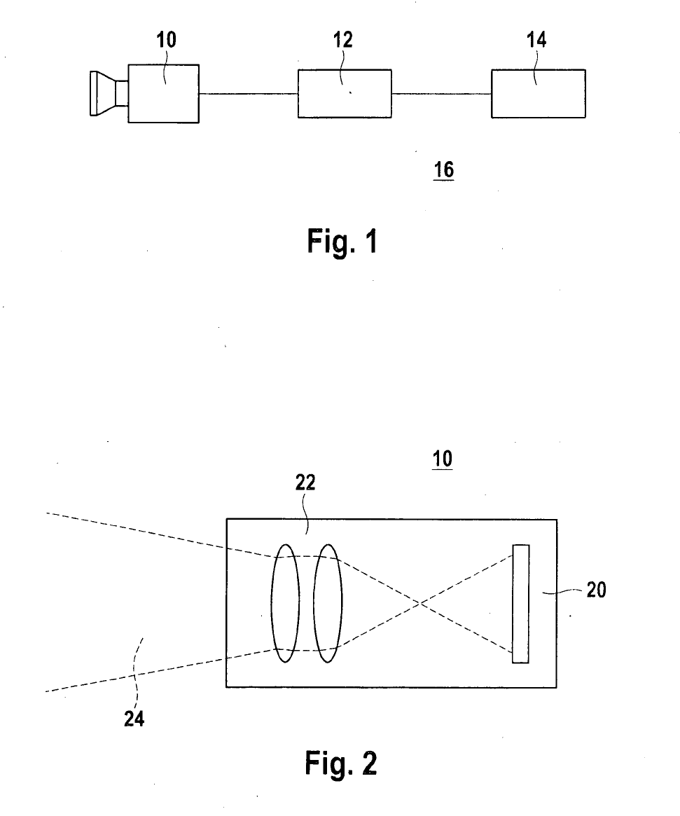

FIG. 1 shows a camera system 16 including a camera 10 and an analyzer unit 12. Camera 10 generates image signals and transmits the generated image signals to analyzer unit 12. After the image signals have been processed by analyzer unit 12, the processed image signals are conveyed to a downstream system 14. Analyzer unit 12 is designed as a separate control unit in the preferred exemplary embodiment. In a variant of the preferred exemplary embodiment, analyzer unit 12 is an integral component of camera 10 and/or of downstream system 14. In the preferred exemplary embodiment, the image signals in analyzer unit 12 are processed in a digital computer unit and in a software program. In the preferred exemplary embodiment, downstream system 14 is a display unit, e.g., a screen, which displays the processed image signals. Alternatively or additionally, an application-specific control and/or actuator device is/are used as downstream system 14 in a variant of the preferred exemplary embodiment. The control and/or actuator device is/are preferably designed as an adjustable lighting system and/or as an actively guided steering system.

FIG. 2 shows camera 10 including an image sensor 20 and a lens 22. Light from surroundings 24 is projected through lens 22 onto image sensor 20.

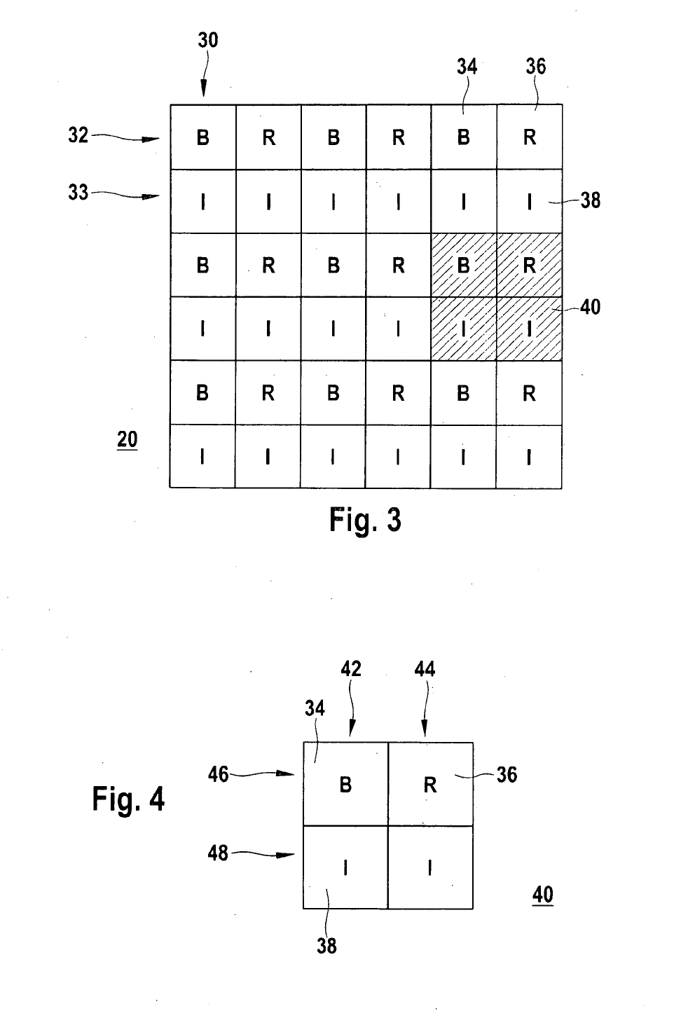

FIG. 3 shows image sensor 20 including light-sensitive elements 34, 36, 38 situated in rows 32, 33 and columns 30. Image sensor 20 has a repeating pattern including two adjacent rows 32, 33, first row 32 having alternating light-sensitive elements 34 having a blue filter B and light-sensitive elements 36 having a red filter R. Light-sensitive elements 38 of second row 33 have no color filter I, in particular light-sensitive elements 38 of second row 33 have no blue filter B or red filter R. In the preferred exemplary embodiment, image sensor 20 is designed as a CMOS image sensor. In a variant of the preferred exemplary embodiment, image sensor 20 is designed as a CCD image sensor. Moreover, a 2×2 matrix 40 of light-sensitive elements 34, 36, 38 is marked as a section of image sensor 20 in FIG. 3. This 2×2 matrix 40 is explained with reference to FIG. 4.

FIG. 4 shows a 2×2 matrix 40 of the image sensor according to FIG. 3. Light-sensitive element 34 of first row 46 and first column 42 of 2×2 matrix 40 have a blue filter B, while light-sensitive element 36 of first row 46 and second column 44 of 2×2 matrix 40 have a red filter R. Light-sensitive elements 38 of second row 48 of 2×2 matrix 40 have neither a blue filter B nor a red filter R. In fact, light-sensitive elements 38 of second row 48 have no color filter I at all in both first column 42 and in second column 44. 2×2 matrix 40 thus represents a BRII pattern (blue-red-intensity-intensity color pattern).

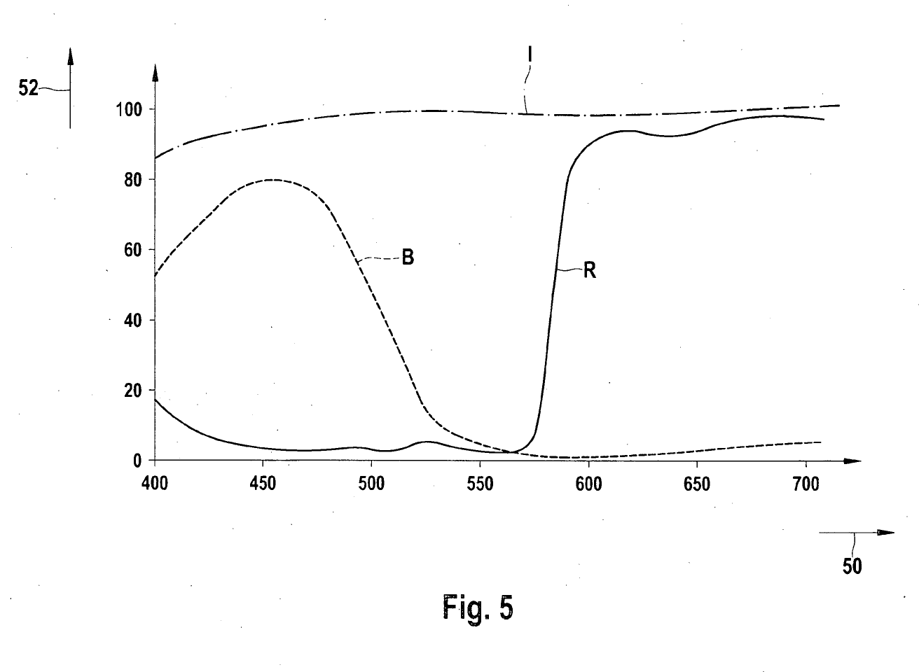

FIG. 5 shows a diagram of the transmission curves of blue filter B and red filter R. Wavelength 50 of the incident light is plotted on the abscissa in nm, while the light transmission of filter 52 is plotted in percent based on the incident light. As can be seen from the diagram, blue filter B has a maximum light transmission at wavelengths of approximately 450 nm, while blue filter B has almost no light transmission for light having wavelengths greater than 550 nm. In contrast, red filter R has a blocking effect for light having wavelengths below 570 nm. The light transmission of red filter R for light having wavelengths greater than 580 nm is almost 100%. For comparison, the diagram shows light transmission I without a color filter. The light transmission of the layer without a selective filter effect on the light-sensitive element (pixel) is almost 100% for the entire visible spectral range from 400 nm to 700 nm. Depending on the quality of the color filter and the filter material used, the transmission curves of blue filter B and red filter R may be different, the curves being similar in particular with respect to the wavelength range. In the preferred exemplary embodiment, the color filters are applied to the semiconductor material during the manufacturing process of the image sensor to ensure that the intended light-sensitive elements (pixels) are covered with the appropriate color mask. In a variant of the preferred exemplary embodiment, microlenses are additionally applied to the individual color filters of the light-sensitive elements so that the attenuation caused by the color filters is at least partially compensated for.

As explained above with reference to FIG. 1, the image signals generated by the camera are processed by the analyzer unit using image processing algorithms. Due to the three different types of light-sensitive elements having the three different types of filters (B, R, I), the image signals of the individual pixels are differently interpreted by the image processing algorithms, and an analysis adapted thereto is carried out. In the exemplary embodiment, the analyzer unit interpolates the color-filtered pixels into intensity pixels by using the respective overlying and subjacent row for reconstruction, thereby incorporating the color-filtered pixels in the interpolation. Moreover, the analyzer unit compares the image signals of a light-sensitive element having a red filter with the image signals of the adjacent light-sensitive element having a blue filter and/or the next light-sensitive element without a color mask. In addition, the analyzer unit performs an analysis of whether an object in the detection range is red by checking whether blue color components are present. If there are red and also blue color components present, the analyzer unit concludes that there is a white object. The analyzer unit is designed in such a way that the analyzer unit is able to distinguish between white and red objects by analyzing the image signals of the light-sensitive elements.

In the exemplary embodiment, the analyzer unit is designed in such a way that the analyzer unit distinguishes between red tail lights and white low beams of motor vehicles. For this purpose, the analyzer unit performs in a first step an object segmentation of red and white image areas in order to classify in a second step the segmented image areas as low beams of motor vehicles and/or tail lights of motor vehicles.

In a further variant of the exemplary embodiment, the analyzer unit is designed in such a way as to be able to distinguish between white and yellow roadway markings, e.g., lane rows. A yellow color marking has a higher component of red compared to a white row and/or a lower component of blue. This enables a reliable differentiation between white and yellow roadway markings so that in the case of a driver assistance system a warning is reliably issued to the driver when leaving the lane, as well as when yellow roadway markings are present. Moreover, the analyzer unit of the exemplary embodiment is designed in such a way that in a first process step an analysis takes place only as a function of the image signals of the light-sensitive elements without color filters and only in the second process step the image signals of the light-sensitive elements having the blue filters and red filters are also analyzed for obtaining color information.

1-10. (canceled)

11. An image sensor, comprising:
a plurality of light-sensitive elements including at least one 2×2 matrix of light-sensitive elements, wherein a light-sensitive element of the first row and the first column of the 2×2 matrix has a blue filter, and wherein a light-sensitive element of the first row and the second column of the 2×2 matrix has a red filter, and wherein the two light-sensitive elements of the second row of the 2×2 matrix have neither a blue filter nor a red filter.

12. The image sensor as recited in claim 11, wherein the two light-sensitive elements of the second row of the 2×2 matrix have no color filter.

13. The image sensor as recited in claim 11, wherein the image sensor has at least two adjacent rows each having at least four columns, the first row having alternating light-sensitive elements having a blue filter and light-sensitive elements having a red filter, and the second row having light-sensitive elements without blue filters and without red filters.

14. The image sensor as recited in claim 13, wherein the light-sensitive elements of the second row have no color filters.

15. The image sensor as recited in claim 14, wherein the image sensor is a CMOS image sensor.

16. A camera system, comprising:
a lens; and
an image sensor having a plurality of light-sensitive elements including at least one 2×2 matrix of light-sensitive elements, wherein a light-sensitive element of the first row and the first column of the 2×2 matrix has a blue filter, and wherein a light-sensitive element of the first row and the second column of the 2×2 matrix has a red filter, and wherein the two light-sensitive elements of the second row of the 2×2 matrix have neither a blue filter nor a red filter.

17. The camera system as recited in claim 16, further comprising:
an analyzer unit for analyzing signals from the image sensor.

18. The camera system as recited in claim 17, wherein the analyzer unit is configured to analyze the signals from the image sensor to distinguish between red and white colors.

19. The camera system as recited in claim 18, wherein the analyzer unit is configured to distinguish between red tail lights and white low beams of motor vehicles.

20. The camera system as recited in claim 17, wherein the analyzer unit is configured distinguish between white and yellow colors.
